(19) United States
(12) Patent Application Publication
(10) Pub. No.: US 2026/0023818 A1
(43) Pub. Date: Jan. 22, 2026

(54) Systems and Methods for a Near Memory-Based Matrix Computation

(71) Applicant: Altera Corporation, San Jose, CA (US)

(72) Inventor: Mukesh Kumar Panda, Bangalore (IN)

(21) Appl. No.: 19/341,998

(22) Filed: Sep. 26, 2025

(51) Int. Cl. G06F 17/16

(52) U.S. Cl. CPC G06F 17/16

(57) ABSTRACT

Systems or methods of the present disclosure may provide an integrated circuit system that includes a programmable logic device that includes a clock, one or more local controllers, programmable logic units implementing a systolic array to compute a matrix multiplication, and embedded memory blocks. The embedded memory blocks include a single port random access memory (SPRAM). The one or more local controllers are configured to, on a first set of alternating clock cycles of the clock, load matrix sub-elements from two rows of a matrix into corresponding matrix element of the SPRAM. The one or more local controllers are configured to, on a second set of alternating clock cycles of the clock, read out the matrix elements from the SPRAM to the systolic array to compute the matrix multiplication.

### BACKGROUND

The present disclosure relates generally to integrated circuits, such as field-programmable gate arrays and/or programmable logic devices. More particularly, the present disclosure relates to matrix computations using integrated circuits.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits may be designed and/or programmed to perform a wide variety of operations. For instance, the integrated circuits may implement neural network engines. For example, integrated circuits may be used to implement Graph Neural Networks (GNNs). These neural networks may use General Matrix Multiplication (GeMM) building blocks embedded in a systolic array and/or attention-based convolutional unit networks. These integrated circuits may provide a capability for repeated multiply and accumulate (MAC) operations over a continuous set of data. These operations include the integrated circuit devices loading of matrix elements into local memory, computing the matrix operations, and storing the results back to memory. The local memory may be relatively large, costly, and/or may be a bottleneck for accelerator-based computations in the integrated circuit.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit system, in accordance with an embodiment of the present disclosure;

FIG. 2 is a block diagram of an example integrated circuit system of FIG. 1, in accordance with an embodiment of the present disclosure;

FIG. 3 is a block diagram of an arrangement of tiles in a matrix multiplication operation, in accordance with an embodiment of the present disclosure;

FIG. 4 is a block diagram of a pipelined process of a matrix multiplication, in accordance with an embodiment of the present disclosure;

FIG. 5 is an example matrix with matrix elements and two tiles, in accordance with an embodiment of the present disclosure;

FIG. 6 is a result of a raster scan using the example matrix of FIG. 5, in accordance with an embodiment of the present disclosure;

FIG. 7 is an example matrix with double-stuffed matrix elements with each containing two sub-elements from two different rows of the example matrix of FIG. 5, in accordance with an embodiment of the present disclosure;

FIG. 8 is an example of a raster scan after read-out from the SPRAM and after a shift register, in accordance with an embodiment of the present disclosure;

FIG. 9 is a flow diagram of a process for utilizing an SPRAM with read and write operations performed on alternating clock cycles, in accordance with an embodiment of the present disclosure; and

FIG. 10 is a block diagram of a data processing system including the integrated circuit system of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

GyANN is an acronym of “Graphs Accelerating Neural Network Engine” that is based on GNN algorithms and embeds GeMM (General Matrix Multiplication) through systolic arrays (SA) (for dense computes) or attention-based convolution units (ACUs) (for sparse computes). This hardware provides a capability for repeated MAC (multiply and accumulate) operations over a continuous set of data arranged in matrix fashion with the enhanced latency, area, and power. For instance, the MAC operations may include a dot-multiplication between two matrices.

Two matrices are stored in DDR for a matrix operation. The matrices are fetched and loaded locally to a RAM. One mechanism may include a dual port RAM (DPRAM) that supports reads and writes on separate ports of the RAM. Alternatively, a single-port RAM (SPRAM) may perform read and writes on alternating clock edges. As discussed herein, devices using SPRAM instead of DPRAM may have a lower performance without modifying the memory management. As discussed herein, the memory stores 2 rows of information of a matrix in a single location of the SPRAM. Thereby, although only writes or reads may occur on each cycle, essentially, alternating reads and writes every other clock cycle has a similar performance to reads and writes on every cycle. Furthermore, since the same amount of storage in DPRAM is physically much smaller in SPRAM, using SPRAM instead of DPRAM reduces the size of the memory drastically. For instance, in TSMR 3 nm for 4 MB of DPRAM may take about 3.1 sq mm while TSMR 3 mm for 4 MB of SPRAM may take around 1.506 sq mm thereby resulting in a size saving of about 50%. Furthermore, dynamic power to utilize access of the SPRAM is reduced by 30% compared to access of the DPRAM due to the alternating cycles of read and write operations.

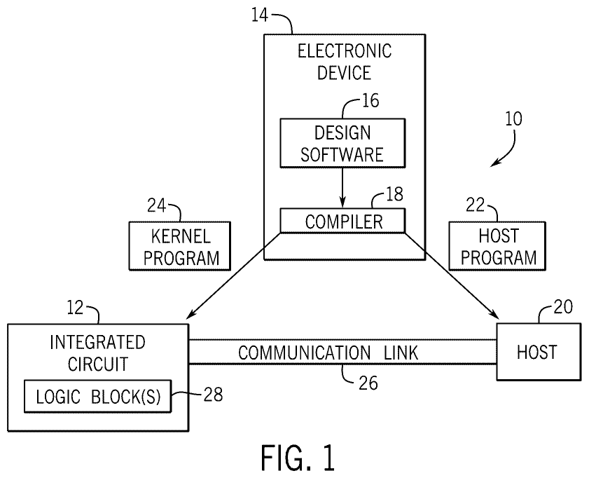

With the foregoing in mind, FIG. 1 illustrates a block diagram of a system 10 that may implement one or more designs on an integrated circuit system 12 (e.g., a single monolithic integrated circuit or a multi-die system of integrated circuits) to perform a wide variety of operations. The integrated circuit system 12 may include a single integrated circuit, multiple integrated circuits in a package, or multiple integrated circuits in multiple packages communicating remotely (e.g., via wires or traces). In some cases, the designer (e.g., user) may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve in comparison to designers may learn unfamiliar low-level hardware description languages to implement new functionalities in the integrated circuit system 12.

The integrated circuit system 12 may include a field-programmable gate array (FPGA) (e.g., Agilex™, Stratix®, Arria®, MAX®, or Cyclone® devices by Altera® Corporation). In a configuration mode of the integrated circuit system 12, a designer may use an electronic device 14 (e.g., a computer) to implement high-level designs (e.g., a system user design) using design software 16, such as a version of Quartus Design Suite® by Altera Corporation. The electronic device 14 may use the design software 16 and a compiler 18 to convert the high-level program into a lower-level description (e.g., a configuration program, a bitstream). The compiler 18 may provide machine-readable instructions representative of the high-level program to a host 20 and the integrated circuit system 12. The design software 16 may include a design tool that generates graphical user interfaces (GUIs) with different views of a design that may be implemented onto the FPGA, for example. The design tool may also provide design context and/or trade-off information associated with the design, as further described herein.

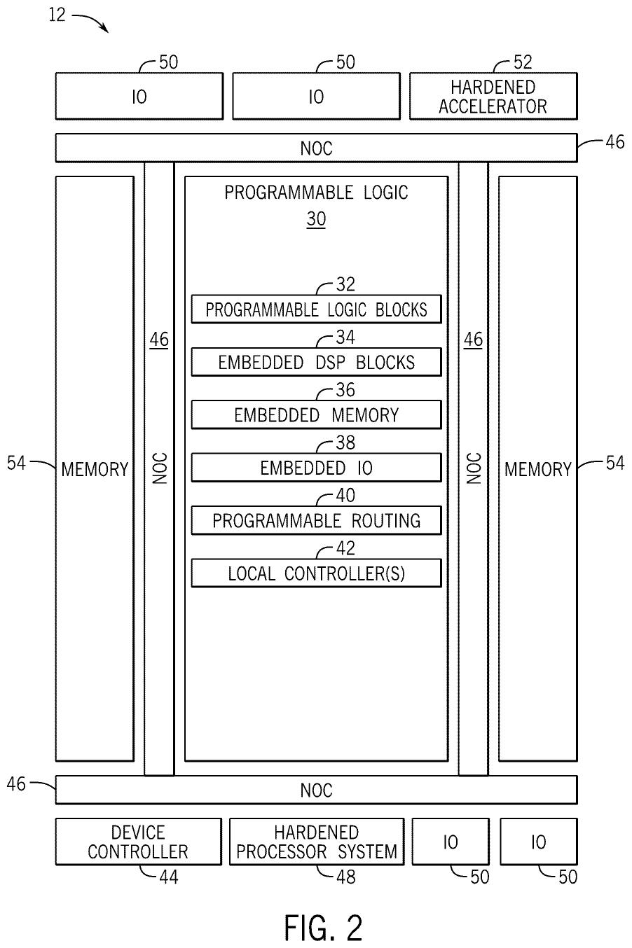

The host 20 may receive a host program 22 that may control or be implemented by a kernel program 24. To implement the host program 22, the host 20 may communicate instructions from the host program 22 to the integrated circuit system 12 via a communication link 26 that may include, for example, direct memory access (DMA) communications or peripheral component interconnect express (PCIe) communications. As will be described in greater detail below in FIG. 2, in some embodiments, the kernel program 24 and the host 20 may enable configuration of a logic block 28 on the integrated circuit system 12. The logic block 28 may include circuitry and/or other logic elements and may be configurable to implement a variety of functions in combination with digital signal processing (DSP) blocks.

The designer may use the design software 16 to generate and/or to specify a low-level program, such as the low-level hardware description languages described above. Further, in some embodiments, the system 10 may be implemented without the host program 22. Thus, embodiments described herein are intended to be illustrative and not limiting.

The integrated circuit system 12 may take any suitable form that may implement the data processing system 14. In one example shown in FIG. 2, the integrated circuit system 12 may include programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any of the programmable logic blocks 32 to implement any desired logic circuitry when configured with the system design configuration 14. The programmable logic blocks 32 and are sometimes referred to as logic array blocks (LABs) or configurable logic blocks (CLBs) that are used to build processing elements (PEs) that are arranged in an SA or an ACU. Each PE in the systolic array computes a partial result as a function of data from its upstream neighbors, stores the partial result, and passes it downstream to the next PE.

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 KB, blocks of 1 MB, blocks of 4 MB, etc.). The embedded memory blocks 36 may be implemented using dual-port RAM (DPRAM) or single-port RAM (SPRAM). Additionally or alternatively, the embedded memory blocks 36 may be implemented as SRAM. The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit system 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit system 12. The device controller 44 may include any suitable logic circuitry to control and/or program the programmable logic circuitry 30 or other elements of the integrated circuit system 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit system 12.

A network-on-chip (NOC) 46 may connect the various elements of the integrated circuit system 12. The NOC 46 may provide rapid, packetized communication to and from the programmable logic circuitry 30 and other blocks, such as a hardened processor system 48, input/output (I/O) blocks 50, a hardened accelerator 52, and local device memory 54. The integrated circuit system 12 may include the hardened processor system 48 when the integrated circuit system 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit system 12. The I/O blocks 50 may enable communication using any suitable communication protocol(s) with other devices outside of the integrated circuit system 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

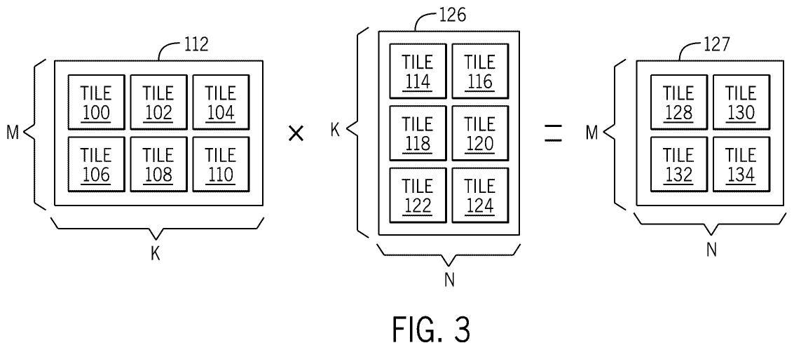

Since matrix elements are loaded into the systolic array of PEs, the matrix elements may be subdivided into collections of matrix elements having a size of a dimension of the systolic array. For example, FIG. 3 shows an arrangement of tiles in a matrix multiplication operation. For instance, tiles 100, 102, 104, 106, 108, and 110 (collectively referred to as tiles 100-110) may be matrix elements of a first matrix A sized to a dimension of the systolic array. For instance, if the systolic array has a size of 64×64 or a size of 4×4, one tile has the same dimension. In other words, the tile has a size that includes the minimum amount of data required to start the compute. Tiles may be organized into hyper-tile (HT), such as HT 112. A HT may represent a set of tiles that can fit within available embedded memory 36. In the illustrated HT 112, the HT 112 includes tiles 100-110 of matrix A. The HT 112 includes a number (M) of rows of the matrix A. For instance, if the tiles 100-110 each have 4 rows, M is 8 rows. The HT 112 also includes a number (K) of columns of the matrix A. For instance, if the tiles 100-110 each have 4 columns, K is 12 columns.

The matrix multiplication also shows tiles 114, 116, 118, 120, 122, and 124 (collectively referred to as tiles 114-124) that are tiles from a matrix B. The tiles 114-124 each have the same dimensions as the tiles 100-110. The tiles 114-124 are arranged into an HT 126 that has K rows of matrix elements and has a number (N) of columns. For instance, if the tiles each have 4 columns, the N is 8. A result of the matrix multiplication of the matrix elements of matrix A from the HT 112 and the HT 126 are stored in HT 127. The HT 127 includes tiles 128, 130, 132, and 134. The HT 127 has N columns and M rows of matrix elements. In some embodiments, the compiler 18 and/or the design software 16 determines the configuration of the HTs, such as the number of tiles in a column of the HT, the number of tiles in a column of the HT, the size of the tiles, and/or other configuration details about the HTs.

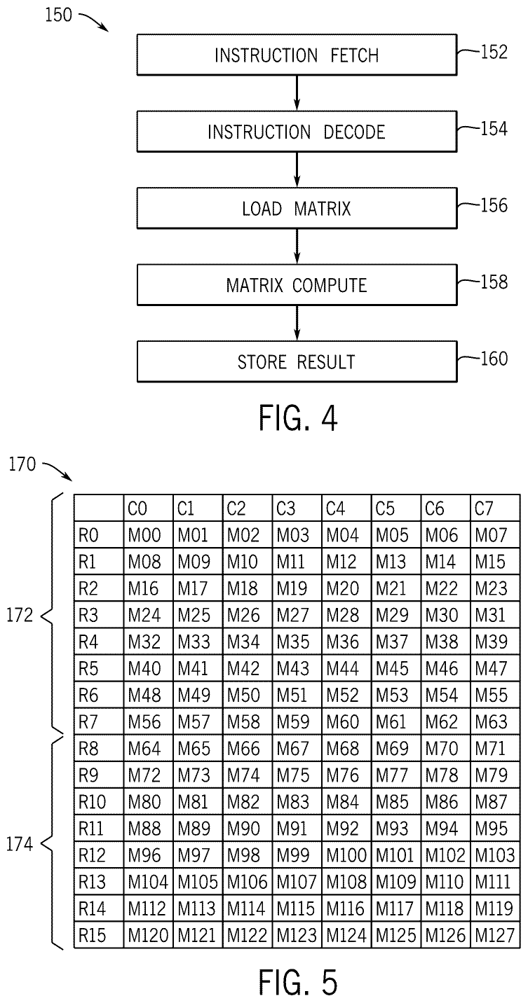

In dense matrix computes using a systolic array, the compute includes 5 stages that may be pipelined. For instance, such pipelining may include moving stored matrix elements from DDR to local SRAM as HTs. FIG. 4 is a block diagram of a pipelined process 150 for performing matrix computes. The process 150 begins after a host processor sends an instruction to the integrated circuit system 12. For instance, a host processor may send an instruction to a decoder that indicates an operation to be performed, the sizes of the matrices, and where the matrices are stored. An instruction decode unit (IDU) (e.g., part of the integrated circuit system 12 and/or the host processor) fetches the instruction (block 152) and decodes the instruction (block 154). The integrated circuit system 12 then loads a matrix (block 156) into embedded memory blocks 36 to be computed by the systolic array. For example, matrix operation may utilize the integrated circuit device 12 as an accelerator for the host processor. The loading of the matrix may include loading multiple matrices into the memory. The systolic array of the integrated circuit system then performs the instructed matrix operation in a matrix compute (block 158). For instance, the matrix compute may include a dot product of the specified at least a portion of the matrices. The integrated circuit device also stores a result (e.g., matrix or vector) back to memory (block 160).

For example, FIG. 5 is an example of a matrix 170 that may be operated on by the integrated circuit system 12. The matrix 170 may be an entire matrix alone and/or may be a subset/part of a bigger matrix. As illustrated, the portion includes a first tile 172 and a second tile 174 where each tile is 8×8 matrix elements M00 to M127.

The load matrix, matrix compute, and store matrix operations may be performed using a raster scan method. In some embodiments, DPRAM is used to store matrix A and matrix B and the final calculated matrix C. Since DPRAM uses one port for loading the DPRAM and another port to extract the matrix compute results, DPRAM may include read and write operations each cycle.

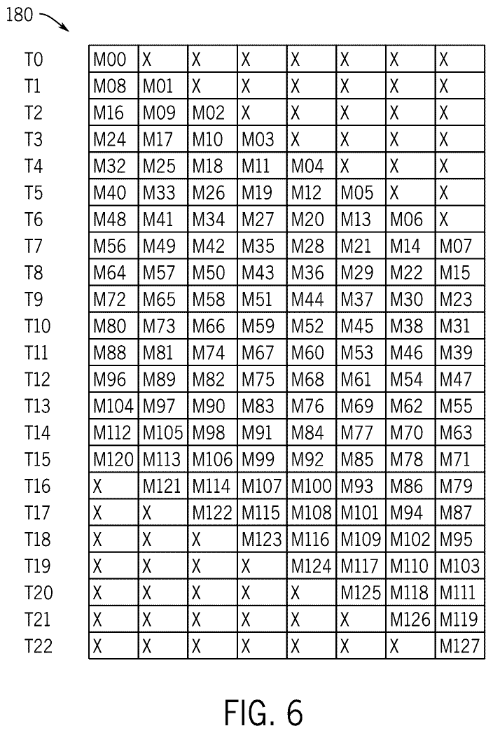

FIG. 6 is a diagram of a raster scan 180 of two tiles of matrix A from FIG. 5 using a DPRAM. In the raster scan, each row corresponds to one clock cycle (e.g., T0, T1, . . . , T23). In other words, rows of matrix elements are extracted on each cycle. For example, when each tile includes 64 matrix elements, the raster scan 180 may be completed in around 23 clock cycles with 22 clock cycles to complete data output and another cycle to shift in registered outputs.

As previously noted, DPRAM may be relatively large when compared to SPRAM. However, DPRAM may enable the DPRAM to read and write data on the same clock cycles. If SPRAM is used instead of DPRAM, read and write operations would be performed on different clock cycles thereby doubling the number of clock cycles to extract the matrix without otherwise modifying the management scheme. Thus, the reduction of the size of SPRAM without modifying the memory management techniques may result in performance loss.

One mechanism of maintaining performance while reducing the size of embedded memory by using SPRAM instead of DPRAM is to widen the SPRAM by a factor of two in relation to the DPRAM while reducing the depth of the SPRAM to ½ of the depth of the DPRAM. By doubling the width of the SPRAM, each row of SPRAM physical memory elements may contain two sub-elements. For example, the sub-elements may include one element from an even row and another element from an odd row of the matrix as shown in the matrix 170 of FIG. 5. For instance, a first double-wide element in row 0 for SPRAM may include the matrix element M00 from row 0 and the matrix element M08 from row 1 of the matrix 170 of FIG. 5. Likewise, a second double-wide element in row 0 for SPRAM may include the matrix element M01 from row 0 and the matrix element M09 of the row 1 of the matrix 170 of FIG. 5.

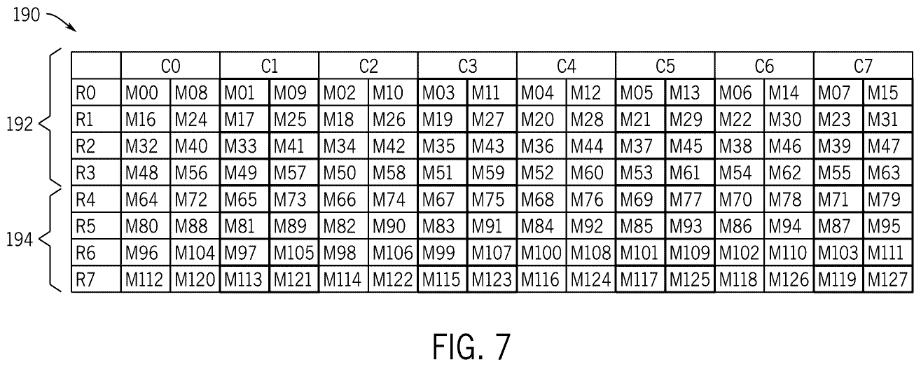

Using such techniques, the matrix 170 for DPRAM may be represented using the matrix 190 of FIG. 7 to include tiles 192 and 194. The tile 192 corresponds to the tile 172, and the tile 194 corresponds to the tile 174. As illustrated, the data is located in 8 rows rather than the 16 rows of FIG. 5 since each row includes the same data from two rows in the matrix 170. As such, each row is double-stuffed with twice as much data with each element formed of two sub-elements. For instance, row R0 includes a first element in column C0 that includes M00 (from R0 of the matrix 170) and M08, a second element in column C1 that includes M01 (from R0 of the matrix 170) and M09 (from RI of the matrix 170), a third element in column C2 that includes M02 (from R0 of the matrix 170) and M10 (from RI of the matrix 170), a fourth element in column C3 that includes M03 (from R0 of the matrix 170) and M11 (from RI of the matrix 170), a fifth element in column C4 that includes M04 (from R0 of the matrix 170) and M12 (from RI of the matrix 170), a sixth element in column C5 that includes M05 (from R0 of the matrix 170) and M13 (from RI of the matrix 170), a seventh element in column C6 that includes M06 (from R0 of the matrix 170) and M14 (from RI of the matrix 170), and an eighth element in column C7 that includes M07 (from R0 of the matrix 170) and M15 (from RI of the matrix 170). Similarly, each row of the matrix 190 may include similarly corresponding data from the matrix 170 with each element including elements from different rows in the matrix 170.

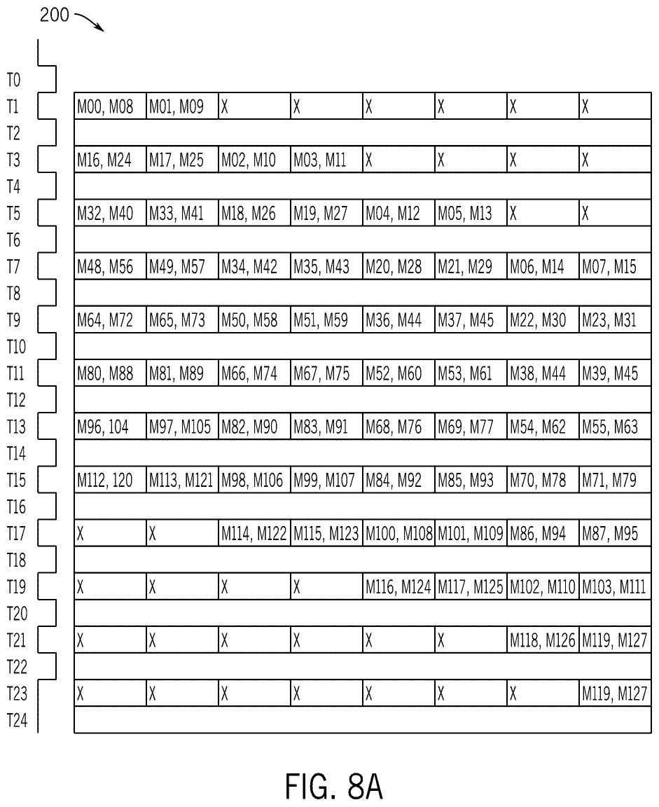

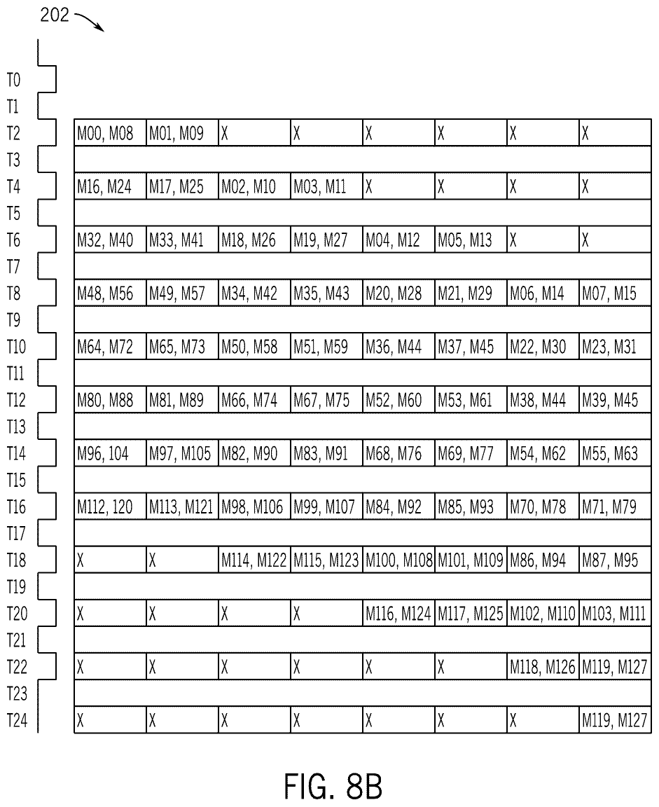

Since SPRAM may not be used to perform read and write operations on the same cycle, the integrated circuit system 12 may instead alternate clock cycles between read and write operations to maintain pipeline integrity. For instance, on odd clock cycles, two rows of the SPRAM may be read out into the systolic array, and in the next even cycle, matrix data may be loaded into the SPRAM (e.g., local SPRAM from DDR). For instance, FIG. 8 illustrates a read data out 200 from the SPRAM in a raster scan along with a shift registered read data 202 on even cycles when data is being loaded into the SPRAM. As illustrated, the raster scan includes reads out from the SPRAM on odd clock cycles and includes loading data into the SPRAM on even clock cycles. As illustrated, with the increased SPRAM width relative to the DPRAM width (and corresponding reduced depth), the SPRAM has a modified memory management with the alternate cycle read and write operations to read 128 elements in the same 23 clock cycles as the DPRAM with a smaller size.

Furthermore, since the read and write operations occur on alternating clock cycles rather than both on each clock cycle, the integrated circuit system 12 implemented with the SPRAM results in a dynamic power utilization that reduces power utilization to less (e.g., 30% less) than DPRAM-based implementations.

Although the foregoing discusses a 2×-wide and ½ deep SPRAM implementation, such techniques may be applied to 2\hat{ }N wide and 1/(2\hat{ }N) deep SPRAM implementations. For instance, when N is 1, the SPRAM may be double wide and half as deep. However, if N is 2, the SPRAM may be four times as wide and one quarter of the depth of the DPRAM implementation. Likewise, if N is 3, the SPRAM may be 8 times as wide and one eighth as deep. These further widths and reduced depths also result in the reduced size of memory by using SPRAM instead of DPRAM and provide similar dynamic power utilization benefits discussed above.

Moreover, although this discussion relates to using odd clock cycles to read out data from the SPRAM and even clock cycles to load in data into the SPRAM, the integrated circuit system 12 may read out data from the SPRAM on even clock cycles and load in data into the SPRAM on odd clock cycles as long as the read and write operations for the SPRAM are alternated or interleaved.

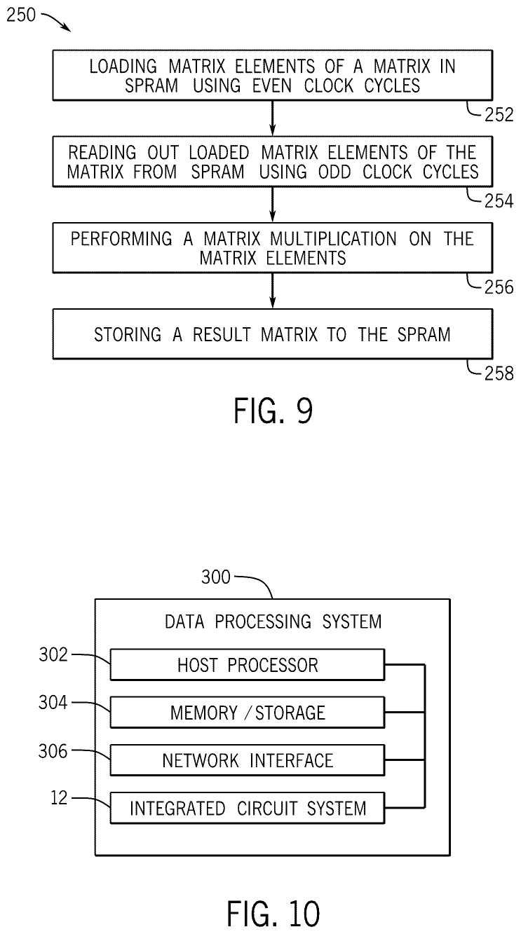

FIG. 9 is a block diagram of a process 250 for utilizing the integrated circuit system 12 with an alternating memory management scheme for a pipelined neural network accelerator-based memory loading system. The process 250 may be performed by the local controller(s) 42, the programmable routing 40, the hardened processor system 48, and/or the device controller 44. The process 250 may be invoked by an instruction from the host processor to cause the programmable logic of the integrated circuit system 12 to act as an accelerator for a matrix multiplication (e.g., dot product). The process 250 includes loading matrix elements in the SPRAM using even clock cycles of the programmable logic device (block 252). The matrix elements may include the double-stuffed matrix elements, such as matrix element in C0 that includes sub-elements M00 and M08 in FIG. 7 and the other such elements of the matrix. The matrix elements may be loaded from another memory, such as DDR.

The process 250 also includes reading out loaded matrix elements of the matrix from the SPRAM using odd clock cycles (block 254). The read-out matrix elements are sent to the systolic array implemented in the programmable logic blocks 32. As such, loading into and reading out of the SPRAM may be performed on alternating clock cycles. Moreover, in some implementations, these alternating clock cycles may be odd clock cycles for loading in the matrix elements and even clock cycles for reading out of the matrix. Moreover, in some embodiments, not every even and odd clock cycle may be used. For instance, when the SPRAM is quadruple wide and ¼ decp, at least two clock cycles may remain unused. Additionally or alternatively, the read operations may be distributed between even or odd clock cycles while write operations are distributed between the other clock cycles. In some implementations, the read and write operations may both use odd or even clock cycles but alternate. For instance, when the SPRAM is quadruple wide and ¼ deep, at least two clock cycles may remain unused, the loading into the SPRAM may use a first cycle, and the reading out from the SPRAM may use a third cycle. Though processes both use odd clock cycles, they still each alternate rather than occur on the same clock cycle.

After an amount (e.g., tile or hypertile) of matrix elements are loaded into the systolic array, the systolic array performs the matrix multiplication as a matrix compute on the matrix elements (block 256). For instance, the systolic array may perform a dot product and/or other matrix operation on the matrix elements and additional matrix elements from another matrix.

After the matrix compute is completed, the process 250 includes storing a result matrix with result matrix elements to the SPRAM (block 258). For instance, the result matrix may include the result HT 127. This storage of the result matrix may also be performed using a raster scan into the SPRAM using alternating clock cycles to write into the SPRAM and to extract the results matrix from the SPRAM (e.g., back to DDR).

The processes discussed above may be carried out on the integrated circuit system 12, which may be a component included in a data processing system, such as a data processing system 300, shown in FIG. 12. The data processing system 300 may include the integrated circuit system 12 (e.g., a programmable logic device), a host processor 302, memory and/or storage circuitry 304, and a network interface 306. The data processing system 300 may include more or fewer components (e.g., electronic display, user interface structures, application specific integrated circuits (ASICs)). The host processor 302 may include any of the foregoing processors that may manage a data processing request for the data processing system 300 (e.g., to perform elaboration and simulation, to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 304 may include random access memory (RAM), read-only memory (ROM), one or more hard drives, flash memory, or the like. The memory and/or storage circuitry 304 may hold data to be processed by the data processing system 300. In some cases, the memory and/or storage circuitry 304 may also store configuration programs (e.g., bitstreams, mapping function) for programming the integrated circuit system 12. The network interface 306 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. In another example, components of the data processing system 300 may be located in separate geographic locations or areas, such as cities, states, or countries.

The data processing system 300 may be part of a data center that processes a variety of different requests. For example, the data processing system 300 may receive a data processing request via the network interface 306 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit system, comprising a programmable logic device, comprising a clock;
one or more local controllers;
   programmable logic units implementing a systolic array to compute a matrix multiplication; and
embedded memory blocks, comprising a single port random access memory (SPRAM), wherein the one or more local controllers is configured to:
on a first set of alternating clock cycles of the clock, load matrix sub-elements from two rows of a matrix into corresponding matrix element of the SPRAM; and
on a second set of alternating clock cycles of the clock, read out the matrix elements from the SPRAM to the systolic array to compute the matrix multiplication.
EXAMPLE EMBODIMENT 2. The integrated circuit system of example embodiment 1, wherein the one or more local controllers are configured to load the matrix sub-elements and read out the matrix elements in a raster scan of the embedded memory blocks.
EXAMPLE EMBODIMENT 3. The integrated circuit system of example embodiment 1, wherein loading the matrix sub-elements and reading out the matrix elements do not occur on the same clock cycle.
EXAMPLE EMBODIMENT 4. The integrated circuit system of example embodiment 1, wherein the first set of alternating clock cycles comprises even clock cycles of the clock, and the second set of alternating clock cycles comprises odd clock cycles of the clock.
EXAMPLE EMBODIMENT 5. The integrated circuit system of example embodiment 1, wherein the first set of alternating clock cycles and the second set of alternating clock cycles are interleaved on alternating clock cycles of the clock.
EXAMPLE EMBODIMENT 6. The integrated circuit system of example embodiment 1, wherein the programmable logic device comprises a double-data rate dynamic random-access memory (DDR) that the one or more local controllers load the matrix sub-elements from the DDR into the SPRAM during the first set of alternating clock cycles.
EXAMPLE EMBODIMENT 7. The integrated circuit system of example embodiment 1, comprising a host processor that is to send an instruction to the programmable logic device to perform a matrix multiplication as an accelerator for the host processor.
EXAMPLE EMBODIMENT 8. The integrated circuit system of example embodiment 7, wherein the matrix multiplication comprises the one or more local controllers to:
   load the matrix into the SPRAM using the first set of alternating clock cycles;
   perform the compute in the systolic array; and
   store a result of the compute in the SPRAM.
EXAMPLE EMBODIMENT 9. The integrated circuit system of example embodiment 8, wherein storing the result in the SPRAM comprises:
writing to the SPRAM using the first of alternating clock cycles; and
reading the stored result from the SPRAM using the second set of alternating clock cycles.
EXAMPLE EMBODIMENT 10. A method for computing a matrix multiplication in a programmable logic device, comprising:
   loading a plurality of matrix elements of a matrix in a single-port random access memory (SPRAM) of the programmable logic device using even clock cycles of a clock of the programmable logic device, wherein each of the plurality of matrix elements comprises matrix sub-elements from two rows of a matrix;
   reading out the loaded plurality of matrix elements from the SPRAM to a systolic array of the programmable logic device using odd clock cycles of the clock;
   performing the matrix multiplication on the matrix in the systolic array; and
   storing a result matrix to the SPRAM.
EXAMPLE EMBODIMENT 11. The method of example embodiment 10, wherein loading the plurality of matrix elements comprises a raster scan of the SPRAM.
EXAMPLE EMBODIMENT 12. The method of example embodiment 10, wherein storing the result matrix to the SPRAM comprises a raster scan of the SPRAM by
   loading result matrix elements of the matrix from the systolic array into the SPRAM using a first of the odd clock cycles or the even clock cycles; and
   reading out the result matrix elements from the SPRAM using a second of the odd clock cycles or the even clock cycles.
EXAMPLE EMBODIMENT 13. The method of example embodiment 12, wherein loading the result matrix elements and reading out the result matrix elements do not occur on the same clock cycles of the clock.
EXAMPLE EMBODIMENT 14. The method of example embodiment 12, wherein reading out the result matrix elements comprises reading out the result matrix elements to a double data rate dynamic random-access memory (DDR) of the programmable logic device from the SPRAM.
EXAMPLE EMBODIMENT 15. The method of example embodiment 10, wherein loading the plurality of matrix elements and reading out the loaded plurality of matrix elements do not occur on the same clock cycles of the clock.
EXAMPLE EMBODIMENT 16. An integrated circuit system, comprising:
   a host processor; and
a programmable logic device, comprising:
   a clock;
one or more local controllers;
   programmable logic units implementing a systolic array to compute a matrix multiplication as an accelerator for the host processor; and
embedded memory blocks, comprising a single port random access memory (SPRAM), wherein the one or more local controllers is configured to:
load a plurality of matrix elements of a matrix for the matrix multiplication into the SPRAM using even clock cycles of the clock, wherein each of the plurality of matrix elements comprises matrix sub-elements from two rows of the matrix;
read out the loaded plurality of matrix elements from the SPRAM to the systolic array using odd clock cycles of the clock;
compute the matrix multiplication on the matrix in the systolic array; and
store a result matrix of a result of the matrix multiplication to the SPRAM.
EXAMPLE EMBODIMENT 17. The integrated circuit system of example embodiment 16, wherein the matrix multiplication comprises a dot product of the matrix with an additional matrix.
EXAMPLE EMBODIMENT 18. The integrated circuit system of example embodiment 16, wherein loading the plurality of matrix elements comprises a raster scan of the SPRAM.
EXAMPLE EMBODIMENT 19. The integrated circuit system of example embodiment 18, wherein storing the result matrix to the SPRAM comprises the one or more local controllers performing a raster scan of the SPRAM by:
   loading result matrix elements of the matrix from the systolic array into the SPRAM using a first of the odd clock cycles or the even clock cycles; and
   reading out the result matrix elements from the SPRAM using a second of the odd clock cycles or the even clock cycles.
EXAMPLE EMBODIMENT 20. The integrated circuit of example embodiment 16, wherein storing the result matrix to the SPRAM comprises a raster scan of the SPRAM by
   loading result matrix elements of the matrix from the systolic array into the SPRAM using the odd clock cycles; and
   reading out the result matrix elements from the SPRAM using the even clock cycles.

What is claimed is:

1. An integrated circuit system, comprising:
a programmable logic device, comprising:
a clock;
one or more local controllers;
programmable logic units implementing a systolic array to compute a matrix multiplication; and
embedded memory blocks, comprising a single port random access memory (SPRAM), wherein the one or more local controllers are configured to:
on a first set of alternating clock cycles of the clock, load matrix sub-elements from two rows of a matrix into corresponding matrix elements of the SPRAM; and
on a second set of alternating clock cycles of the clock, read out the matrix elements from the SPRAM to the systolic array to compute the matrix multiplication.

2. The integrated circuit system of claim 1, wherein the one or more local controllers are configured to load the matrix sub-elements and read out the matrix elements in a raster scan of the embedded memory blocks.

3. The integrated circuit system of claim 1, wherein loading the matrix sub-elements and reading out the matrix elements do not occur on the same clock cycle.

4. The integrated circuit system of claim 1, wherein the first set of alternating clock cycles comprises even clock cycles of the clock, and the second set of alternating clock cycles comprises odd clock cycles of the clock.

5. The integrated circuit system of claim 1, wherein the first set of alternating clock cycles and the second set of alternating clock cycles are interleaved on alternating clock cycles of the clock.

6. The integrated circuit system of claim 1, wherein the programmable logic device comprises a double data rate dynamic random-access memory (DDR) that the one or more local controllers load the matrix sub-elements from the DDR into the SPRAM during the first set of alternating clock cycles.

7. The integrated circuit system of claim 1, comprising a host processor that is to send an instruction to the programmable logic device to perform the matrix multiplication as an accelerator for the host processor.

8. The integrated circuit system of claim 7, wherein the matrix multiplication comprises the one or more local controllers to:
load the matrix into the SPRAM using the first set of alternating clock cycles;
perform the compute in the systolic array; and
store a result of the compute in the SPRAM.

9. The integrated circuit system of claim 8, wherein storing the result in the SPRAM comprises:
writing to the SPRAM using the first set of alternating clock cycles; and
reading the stored result from the SPRAM using the second set of alternating clock cycles.

10. A method for computing a matrix multiplication in a programmable logic device, comprising:
loading a plurality of matrix elements of a matrix in a single-port random access memory (SPRAM) of the programmable logic device using even clock cycles of a clock of the programmable logic device, wherein each of the plurality of matrix elements comprises matrix sub-elements from two rows of a matrix;
reading out the loaded plurality of matrix elements from the SPRAM to a systolic array of the programmable logic device using odd clock cycles of the clock;
performing the matrix multiplication on the matrix in the systolic array; and
storing a result matrix to the SPRAM.

11. The method of claim 10, wherein loading the plurality of matrix elements comprises a raster scan of the SPRAM.

12. The method of claim 10, wherein storing the result matrix to the SPRAM comprises a raster scan of the SPRAM by:
loading result matrix elements of the matrix from the systolic array into the SPRAM using a first set of the odd clock cycles or the even clock cycles; and
reading out the result matrix elements from the SPRAM using a second set of the odd clock cycles or the even clock cycles.

13. The method of claim 12, wherein loading the result matrix elements and reading out the result matrix elements do not occur on the same clock cycles of the clock.

14. The method of claim 12, wherein reading out the result matrix elements comprises reading out the result matrix elements to a double data rate dynamic random-access memory (DDR) of the programmable logic device from the SPRAM.

15. The method of claim 10, wherein loading the plurality of matrix elements and reading out the loaded plurality of matrix elements do not occur on the same clock cycles of the clock.

16. An integrated circuit system, comprising:
a host processor; and
a programmable logic device, comprising:
a clock;
one or more local controllers;
programmable logic units implementing a systolic array to compute a matrix multiplication as an accelerator for the host processor; and
embedded memory blocks, comprising a single port random access memory (SPRAM), wherein the one or more local controllers are configured to:
load a plurality of matrix elements of a matrix for the matrix multiplication into the SPRAM using even clock cycles of the clock;
read out the loaded plurality of matrix elements from the SPRAM to the systolic array using odd clock cycles of the clock;
compute the matrix multiplication on the matrix in the systolic array; and
store a result matrix of a result of the matrix multiplication to the SPRAM.

17. The integrated circuit system of claim 16, wherein the matrix multiplication comprises a dot product of the matrix with an additional matrix.

18. The integrated circuit system of claim 16, wherein loading the plurality of matrix elements comprises a raster scan of the SPRAM.

19. The integrated circuit system of claim 18, wherein storing the result matrix to the SPRAM comprises the one or more local controllers performing a raster scan of the SPRAM by:
loading result matrix elements of the matrix from the systolic array into the SPRAM using a first set of the odd clock cycles or the even clock cycles; and
reading out the result matrix elements from the SPRAM using a second set of the odd clock cycles or the even clock cycles.

20. The integrated circuit of claim 16, wherein storing the result matrix to the SPRAM comprises a raster scan of the SPRAM by:
loading result matrix elements of the matrix from the systolic array into the SPRAM using the odd clock cycles; and
reading out the result matrix elements from the SPRAM using the even clock cycles.
